(19) United States
(12) Patent Application Publication
(10) Pub. No.: US 2020/0081741 A1
(43) Pub. Date: Mar. 12, 2020

(54) INFORMATION PROCESSING APPARATUS AND MEMORY MANAGEMENT METHOD

(71) Applicant: MITSUBISHI ELECTRIC CORPORATION, Tokyo (JP)

(72) Inventor: Tatsuya MITSUGI, Tokyo (JP)

(73) Assignee: MITSUBISHI ELECTRIC CORPORATION, Tokyo (JP)

(21) Appl. No.: 16/496,840

(22) PCT Filed: May 17, 2017
(86) PCT No.: PCT/JP2017/018544

§ 371 Date: Sep. 23, 2019

(51) Int. Cl. G06F 9/50; G06F 12/0891

(52) U.S. Cl. CPC G06F 9/5016; G06F 9/5022; G06F 2212/1044; G06F 2209/5013; G06F 12/0891

(57) ABSTRACT

A memory management system of an operating system includes a memory manager and a system cache free-up unit. The memory manager monitors a free space of a memory. Upon detecting a shortage of the free space of the memory, the memory manager terminates any of running processes to increase the free space of the memory. The system cache free-up unit frees up, in the memory, an area reserved as a cache area of the operating system to further increase the free space of the memory when a type or an operating state of the process terminated by the memory manager satisfies a predefined condition.

### TECHNICAL FIELD

The present invention relates to a memory management system that reserves a free space of a memory.

### BACKGROUND ART

Many high functioning operating systems (OSs) incorporated into information processing apparatuses such as personal computers and smart phones adopt memory management systems that forcibly terminate any of running processes to reserve a free space of a memory when the free space of the memory is insufficient. For example, Android (registered trademark) incorporates a memory management system called Low Memory Killer.

The information processing apparatus including such a memory management system can prevent a shortage of the free space of the memory. However, forcibly terminating a process of an application that the user frequently uses prolongs the start-up time when the user next uses the application, which causes a problem of decreasing the usability of the information processing apparatus.

For example, Patent Documents 1 and 2 propose the technologies to solve this problem. The memory management system in Patent Document 1 sets a rank representing a priority to a memory area reserved by each process, and frees up a memory area that is ranked low when the free space of the memory is insufficient. Moreover, the memory management system in Patent Document 2 can set a process with a high priority to a forcible-termination prohibited process.

### PRIOR ART DOCUMENT

### Patent Document

[Patent Document 1] Japanese Unexamined Patent Application Publication No. 2012-221217

[Patent Document 2] Japanese Unexamined Patent Application Publication No. 2008-186167

### SUMMARY

### Problem to be Solved by the Invention

Both of the technologies of Patent Documents 1 and 2 aim at increasing a free space of a memory by terminating a process with a low priority. According to the technology of Patent Document 1, if the free space cannot be sufficiently reserved even by terminating a process with a low priority, a process with a high priority has to be terminated, thus creating the aforementioned problem. According to the technology of Patent Document 2, if many forcible-termination prohibited processes are being operated, the free space of the memory may not be sufficiently reserved.

The present invention has been conceived to solve the problems, and has an object of providing a memory management system that can sufficiently reserve a free space of a memory while preventing forcible termination of a process with a high priority.

### Means to Solve the Problem

A memory management system according to the present invention includes: a memory manager to monitor a free space of a memory to be used for executing a plurality of processes and terminate any of running processes upon detecting a shortage of the free space of the memory to increase the free space of the memory; and a system cache free-up unit to free up, in the memory, an area reserved as a cache area of an operating system to further increase the free space of the memory when a type or an operating state of the process terminated by the memory manager satisfies a predefined condition.

### Effects of the Invention

According to the present invention, when the memory manager terminates a process satisfying a predefined condition, the system cache free-up unit frees up an area reserved as a cache area of an operating system to increase the free space of the memory. The free space of the memory can be effectively increased before the memory management system terminates a process with a high priority, which consequently prevents the memory manager from terminating the process with a high priority. Thus, the free space of the memory can be sufficiently reserved while forcible termination of the process with a high priority is prevented.

The objects, features, aspects and advantages of the present invention will become more apparent from the following detailed description and the accompanying drawings.

### BRIEF DESCRIPTION OF DRAWINGS

FIG. 1 is a block diagram conceptually illustrating a configuration of main units of an information processing apparatus according to an embodiment of the present invention.

FIG. 2 illustrates an example relationship between a type or an operating state and a priority of each process, and a threshold of a free space.

FIG. 3 illustrates an example description of a configuration file.

FIG. 4 illustrates operations of a memory management system according to the embodiment of the present invention.

FIG. 5 illustrates the operations of the memory management system according to the embodiment of the present invention.

FIG. 6 illustrates the operations of the memory management system according to the embodiment of the present invention.

FIG. 7 illustrates the operations of the memory management system according to the embodiment of the present invention.

FIG. 8 illustrates operations of Low Memory Killer.

FIG. 9 illustrates the operations of Low Memory Killer.

FIG. 10 illustrates the operations of Low Memory Killer.

FIG. 11 illustrates the operations of Low Memory Killer.

FIG. 12 is a flowchart illustrating the operations of the memory management system according to the embodiment of the present invention.

### DESCRIPTION OF EMBODIMENTS

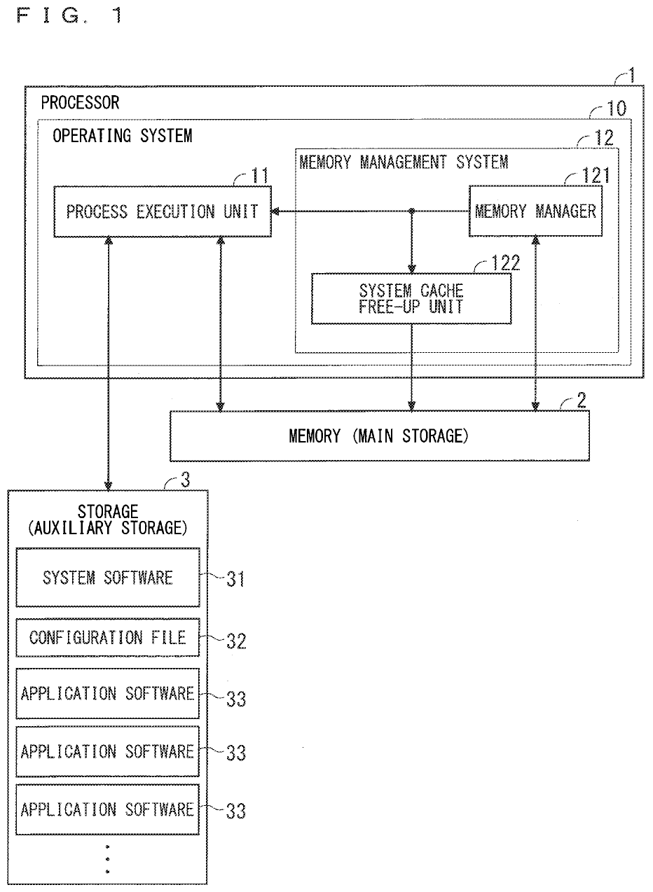

FIG. 1 is a block diagram conceptually illustrating a configuration of main units of an information processing apparatus according to an embodiment of the present invention. As illustrated in FIG. 1, the information processing apparatus includes a processor 1, a memory 2, and storage 3. Specific examples of the information processing apparatus include personal computers, smart phones, tablet terminals, navigation apparatuses, and audio display systems. For example, when the information processing apparatus is a portable device such as a smart phone or a tablet terminal, illustration of the constituent elements other than those illustrated in FIG. 1, for example, an image display unit, an audio output unit, and an operation input unit is omitted though these constituent elements are included in the information processing apparatus.

The processor 1 executes software (a program) to implement various functions. The processor 1 is sometimes referred to as, for example, a central processing unit (CPU), a processing unit, an arithmetic unit, a microprocessor, a microcomputer, or a digital signal processor (DSP).

The memory 2 is main storage of the processor 1 and includes, for example, a random access memory (RAM). When executing software, the processor 1 causes the memory 2 to store data or a program necessary for the execution.

The storage 3 is auxiliary storage of the processor 1 and stores, for example, a program of the software to be executed by the processor 1. Here, the storage 3 stores system software 31 for building an operating system 10, a configuration file 32 describing various set values, and a plurality of pieces of application software 33 (will be hereinafter simply referred to as “applications 33”).

Examples of the storage 3 include semiconductor memories such as a read-only memory (ROM), a flash memory, an erasable programmable read-only memory (EPROM), and an electrically erasable programmable read-only memory (EEPROM), a hard disk drive (HDD), an optical disk, a magnetic disk, and a flexible disk. The storage 3 may be a combination of these storage mediums. For example, the storage 3 may take a form of storing the system software 31 and the configuration file 32 in the ROM and storing the applications 33 in a memory card functioning as a flash memory.

The processor 1 executes the system software 31 stored in the storage 3 to build the operating system 10. The operating system 10 includes functional blocks of a process execution unit 11 and a memory management system 12.

The process execution unit 11 executes the applications 33 stored in the storage 3, according to a user operation or an instruction of the operating system 10. In other words, the process execution unit 11 executes various processes according to programs of the applications 33. The process execution unit 11 can simultaneously execute processes of a plurality of the applications 33. The process execution unit 11 may run a plurality of processes using one of the applications 33.

The memory management system 12 performs a process for resolving a shortage of a free space of the memory 2 upon its occurrence. As illustrated in FIG. 1, the memory management system 12 includes a memory manager 121 and a system cache free-up unit 122.

The memory manager 121 monitors a free space of the memory 2. Upon detecting a shortage of the free space of the memory 2, the memory manager 121 terminates any of running processes to increase the free space of the memory 2. Specifically, when detecting that the free space of the memory 2 is smaller than a predefined threshold, the memory manager 121 selects a process to be terminated from among the running processes, and outputs, to the process execution unit 11, a signal requesting termination of the selected process. When the operating system 10 is, for example, Android, the memory manager 121 should be known Low Memory Killer.

The system cache free-up unit 122 monitors the signal output by the memory manager 121 to identify which process has been terminated by the memory manager 121, and checks the type and the operating state (indicating an operating state immediately before the termination) of the process. When the type or the operating state of the process terminated by the memory manager 121 satisfies a predefined trigger condition, the system cache free-up unit 122 frees up, in the memory 2, an area reserved as a cache area of the operating system 10 (will be hereinafter referred to as a “system cache area”) to further increase the free space of the memory 2. Specific examples of the trigger condition will be described later.

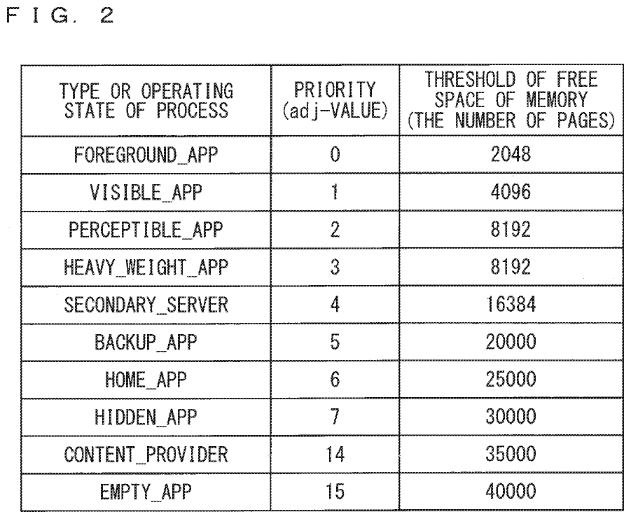

Assume that the operating system 10 is Android and the memory manager 121 is Low Memory Killer in the embodiment. In Low Memory Killer, running processes are classified into a plurality of genres, based on a type and an operating state of each of the processes as illustrated in FIG. 2. Furthermore, an adj-value representing a priority and a threshold of a free space of the memory 2 that is a criterion for determining whether the process is a candidate for forcible termination are defined for each of the genres. As the adj-value is smaller, the priority increases. In FIG. 2, the threshold of the free space of the memory 2 is represented by the number of pages. In Android, 1 page equates to 4 kB. For example, 2048 pages mean 4 kB×2048=8192 kB.

In FIG. 2, “FOREGROUND_APP” is a process operating in the foreground. The adj-value is set to 0, and the threshold of the free space is set to 2048. “VISIBLE_APP” is a process in a state where a part or the entirety of the run screen is displayed on a display unit. The adj-value is set to 1, and the threshold of the free space is set to 4096. “PERCEPTIBLE_APP” is a process operating in the background whose operation can be perceived by the user (for example, a state of playing back music). The adj-value is set to 2, and the threshold of the free space is set to 8192.

“HEAVY_WEIGHT_APP” is a process whose load to the processor 1 or the memory 2 is heavy. The adj-value is set to 3, and the threshold of the free space is set to 8192. “SECONDARY_SERVER” is a process for providing another process with a function. The adj-value is set to 4, and the threshold of the free space is set to 16384. “BACKUP_APP” is a process for backing up data. The adj-value is set to 5, and the threshold of the free space is set to 20000.

“HOME_APP” is a process for displaying a home screen for the user to run an application (i.e., a process of a drawer or a home application). The adj-value is set to 6, and the threshold of the free space is set to 25000. “HIDDEN_APP” is a process operating in the background whose operation cannot be perceived by the user. The adj-value is set to 7, and the threshold of the free space is set to 30000. “CONTENT_PROVIDER” is a process for sharing data between a plurality of processes. The adj-value is set to 14, and the threshold of the free space is set to 35000. “EMPTY_APP” is a process during which none is executed. The adj-value is set to 15, and the threshold of the free space is set to 40000.

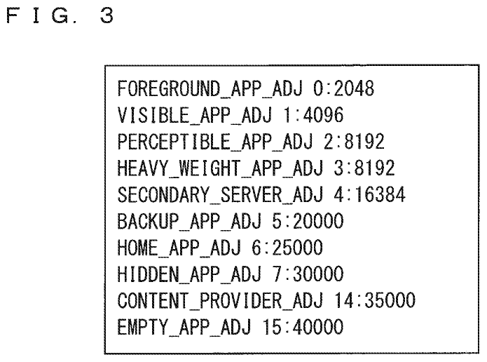

The set values illustrated in FIG. 2 are described in the configuration file 32 in a format illustrated in FIG. 3, and are read by the memory management system 12 upon startup of the operating system 10.

When the free space of the memory 2 falls below a certain value, Low Memory Killer selects a candidate process to be terminated, based on the free space of the memory 2. For example, when the set values illustrated in FIG. 2 are set to Low Memory Killer, Low Memory Killer runs when the free space of the memory 2 is smaller than 40000 pages (160000 kB). For example, when the free space of the memory 2 falls below 30000 pages (120000 kB), Low Memory Killer selects a process whose adj-value is 7 or more as the candidate process to be terminated. When the free space of the memory 2 falls below 20000 pages (80000 kB), Low Memory Killer selects a process whose adj-value is 5 or more as the candidate process to be terminated.

When finding a plurality of candidate processes to be terminated, Low Memory Killer terminates a process with the lowest priority, that is, a process with the highest adj-value among the candidate processes. When finding a plurality of processes with the lowest priority among the candidate processes to be terminated, Low Memory Killer terminates a process with the largest memory usage among the plurality of processes. Low Memory Killer repeats such processes until the free space of the memory 2 is larger than or equal to a certain value or until there is no candidate process to be terminated.

The trigger condition is set to the system cache free-up unit 122, based on the process genres illustrated in FIG. 2. A genre with a priority lower than that of a process preferably prevented from being terminated by the memory manager 121 (Low Memory Killer) is set to the trigger condition.

In the embodiment, the memory manager 121 (Low Memory Killer) prevents processes with a priority higher than or equal to that of “HOME_APP” from being terminated. In this case, process genres with priorities lower than that of “HOME_APP” are set as process genres satisfying the trigger condition. Here, “HIDDEN_APP”, “CONTENT_PROVIDER”, and “EMPTY_APP” are set to the process genres satisfying the trigger condition. The set value of the trigger condition is described in the configuration file 32 stored in the storage 3.

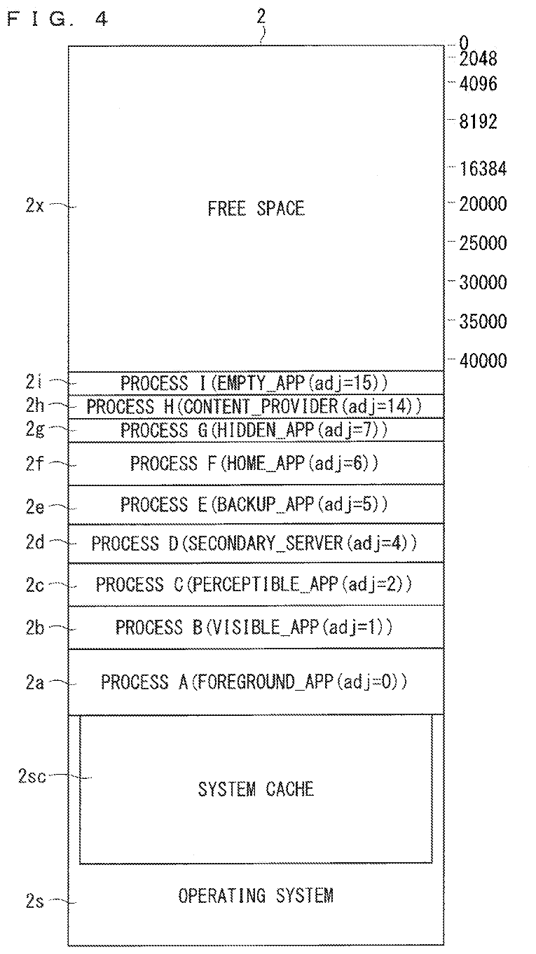

Hereinafter, operations of the memory management system 12 of the information processing apparatus will be described with the specific examples. FIG. 4 illustrates example memory areas to be reserved in the memory 2. First, a memory area 2s for the operating system 10 (will be hereinafter referred to as a “system memory area 2s ”) is reserved in the memory 2. The system memory area 2s includes a cache area 2sc to be used by the operating system 10 to shorten a reaction time for a user operation (will be hereinafter referred to as a “system cache area 2sc”).

Here, the size of the area reserved as the system memory area 2s is not fixed. As data that the operating system 10 caches in the memory 2 increases, the system cache area 2sc gradually increases, and the system memory area 2s increases accordingly.

Here, the process execution unit 11 executes each of the following: a process A classified as “FOREGROUND_APP”; a process B classified as “VISIBLE_APP”; a process C classified as “PERCEPTIBLE_APP”; a process D classified as “SECONDARY_SERVER”; a process E classified as “BACKUP_APP”; a process F classified as “HOME_APP”; a process G classified as “HIDDEN_APP”; a process H classified as “CONTENT_PROVIDER”; and a process I classified as “EMPTY_APP”. In the memory 2, memory areas 2a to 2i are reserved for the processes A to I, respectively. As illustrated in FIG. 2, 40000 pages (80000 kB) or more are reserved as a free space 2x in the memory 2.

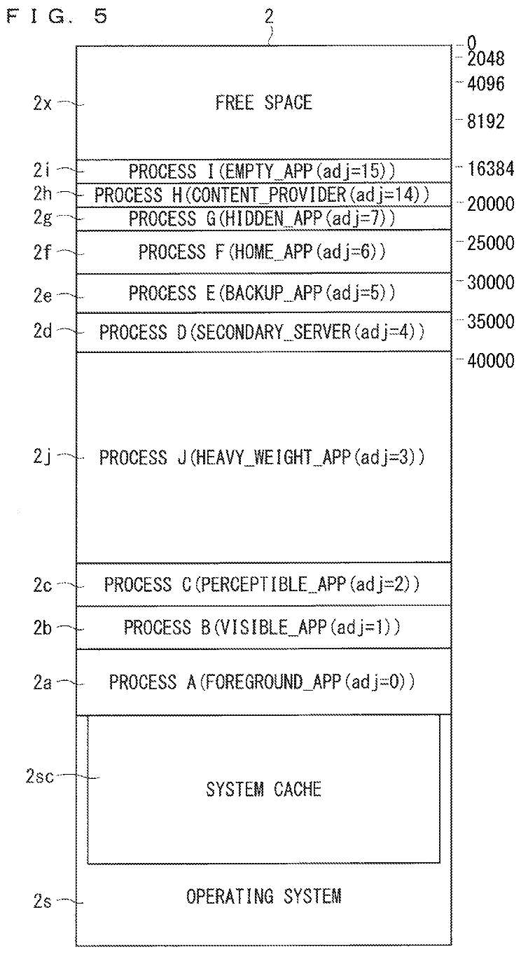

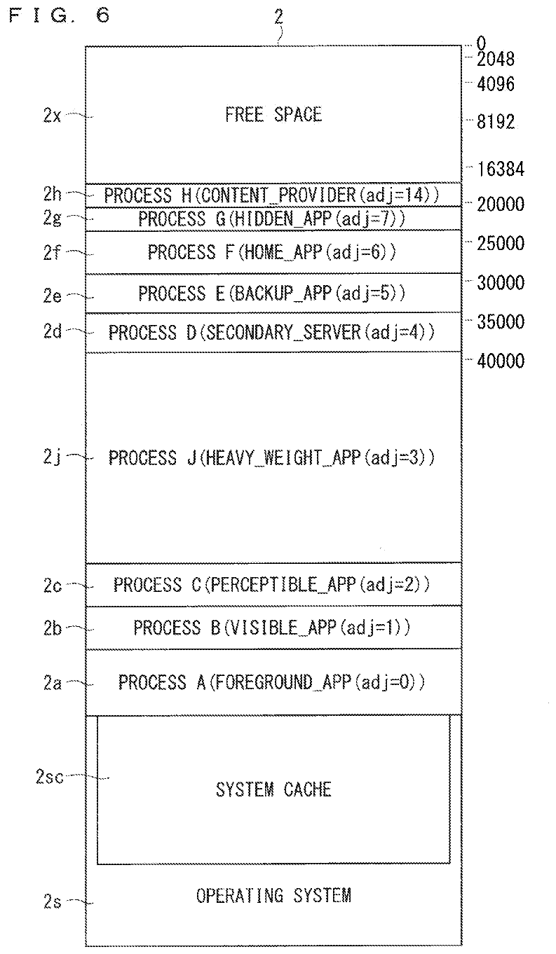

For example, it is assumed that a process J classified as “HEAVY_WEIGHT_APP” is run from the state illustrated in FIG. 4, that a memory area 2j is newly reserved for the process J in the memory 2, and that the free space 2x consequently falls below 16384 pages (65536 kB) as illustrated in FIG. 5. With reference to FIG. 2, the memory manager 121 selects, as candidate processes to be terminated, the process D classified as “SECONDARY_SERVER”, the process E classified as “BACKUP_APP”, the process F classified as “HOME_APP”, the process G classified as “HIDDEN_APP”, the process H classified as “CONTENT_PROVIDER”, and the process I classified as “EMPTY_APP”. Then, the memory manager 121 terminates the process I with the lowest priority (the highest adj-value) among the candidate processes. As a result, the memory area 2i for the process I is freed up to increase the free space 2x by the freed area as illustrated in FIG. 6.

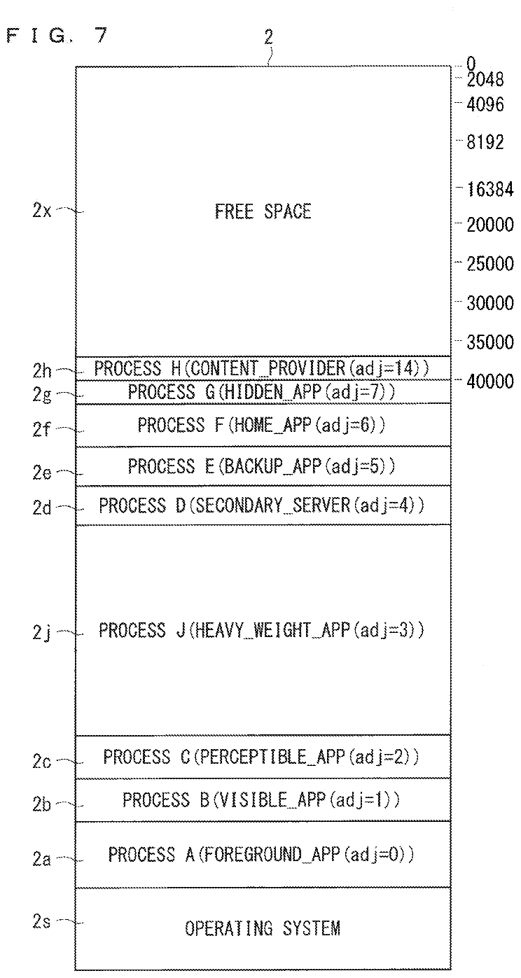

Here, the system cache free-up unit 122 detects that the memory manager 121 has terminated the process I classified as “EMPTY_APP”. Since “EMPTY_APP” is classified into the genre set as the trigger condition in the embodiment, the system cache free-up unit 122 frees up the system cache area 2sc upon detecting that the memory manager 121 has terminated the process I. As a result, the free space 2x is further increased as illustrated in FIG. 7.

Since the free space 2x falls below 40000 pages (160000 kB) in the state illustrated in FIG. 7, the memory manager 121 selects a process classified as “EMPTY_APP” as a candidate process to be terminated if the process is being executed. However, there is no process classified as “EMPTY_APP” among the running processes A to H process in the state illustrated in FIG. 7. Thus, the memory manager 121 does not terminate any of the processes.

Consequently, the process F classified as “HOME_APP” can continue its operation. Since the user frequently runs the process F classified as “HOME_APP”, the continued operation of the process F prevents the usability of the information processing apparatus from decreasing. Although freeing up the system cache area 2sc may temporarily reduce the rate of reaction of the operating system 10, it probably affects the sense of usage of the user less than that when the start-up time of, for example, a process classified as “HOME_APP” that the user frequently runs is prolonged.

It is described above as an example that all the “HIDDEN_APP”, the “CONTENT_PROVIDER”, and the “EMPTY_APP” with priorities lower than that of “HOME_APP” preferably avoided from its forcible termination are set to the process genres satisfying the trigger condition. However, one or more of these should be set to the process genres satisfying the trigger condition. For example, if the “EMPTY_APP” is excluded from the process genres satisfying the trigger condition, the system cache area 2sc is not freed up by merely terminating the “EMPTY_APP” through the memory manager 121. Thus, the frequency of freeing up the system cache area 2sc can be reduced more than that of the aforementioned example.

Consequently, it is possible in the embodiment to prevent the memory manager 121 from terminating the process F classified as “HOME_APP”. To clarify this advantage, operations of Low Memory Killer that is a conventional memory management system will be hereafter described.

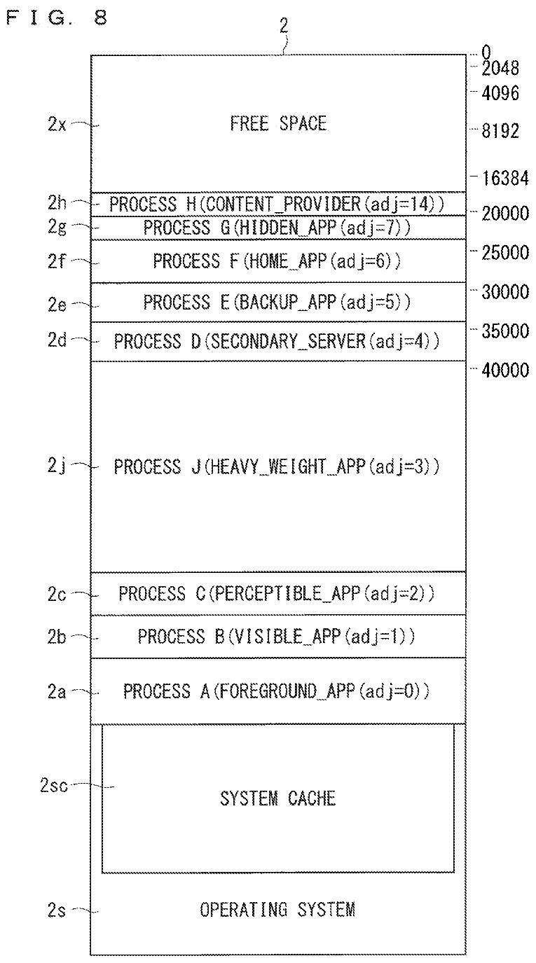

Similarly as the example above, assume that the process J classified as “HEAVY_WEIGHT_APP” is run from the state illustrated in FIG. 4 to render the state illustrated in FIG. 5 and that the free space 2x falls below 16384 pages (65536 kB). Here, Low Memory Killer selects, as candidate processes to be terminated, the process D classified as “SECONDARY_SERVER”, the process E classified as “BACKUP_APP”, the process F classified as “HOME_APP”, the process G classified as “HIDDEN_APP”, the process H classified as “CONTENT_PROVIDER”, and the process I classified as “EMPTY_APP”. Then, Low Memory Killer terminates the process I with the lowest priority among the candidate processes. As a result, the memory area 2i for the process I is freed up to increase the free space 2x by the freed area as illustrated in FIG. 8.

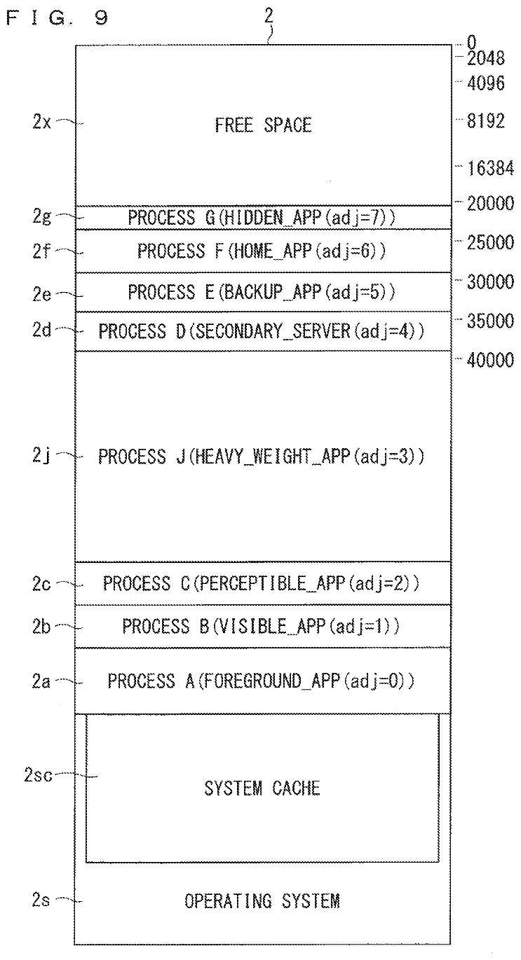

Since the free space 2x falls below 20000 pages (80000 kB) in the state illustrated in FIG. 8, Low Memory Killer selects, as candidate processes to be terminated, the process E classified as “BACKUP_APP”, the process F classified as “HOME_APP”, the process G classified as “HIDDEN_APP”, and the process H classified as “CONTENT_PROVIDER”. Then, Low Memory Killer terminates the process H with the lowest priority among the candidate processes. As a result, the memory area 2h for the process H is freed up to increase the free space 2x by the freed area as illustrated in FIG. 9.

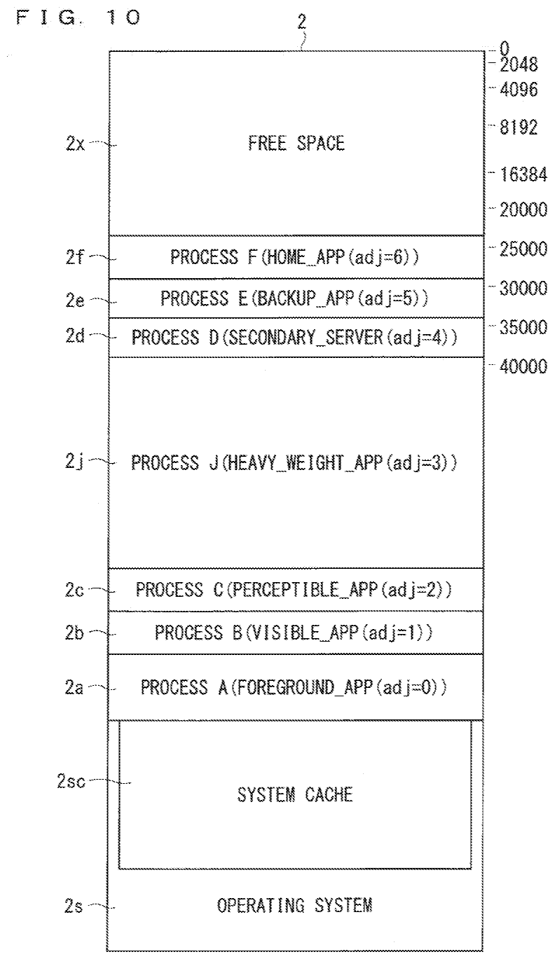

Since, the free space 2x falls below 25000 pages (100000 kB) in the state illustrated in FIG. 9, Low Memory Killer selects, as candidate processes to be terminated, the process F classified as “HOME_APP” and the process G classified as “HIDDEN_APP”. Then, Low Memory Killer terminates the process G with the lowest priority out of the candidate processes. As a result, the memory area 2g for the process G is freed up to increase the free space 2x by the freed area as illustrated in FIG. 10.

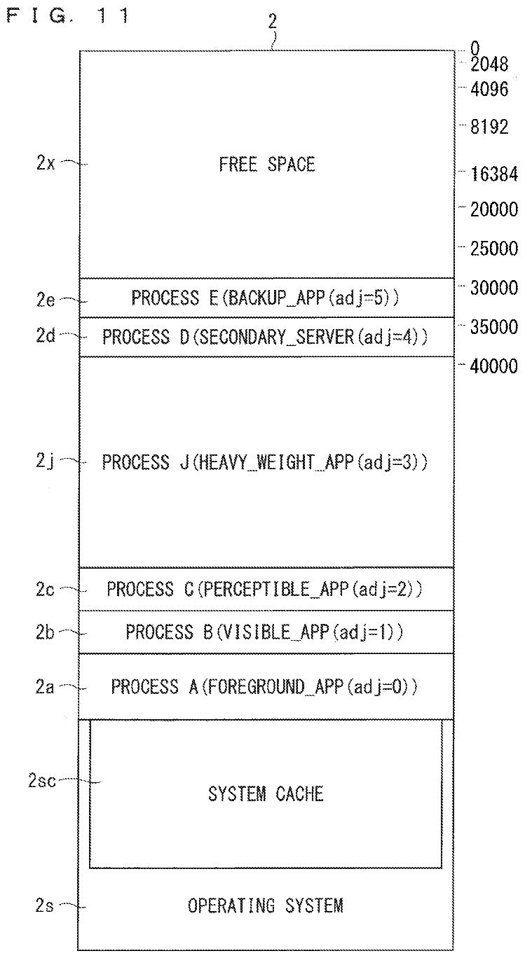

Since the free space 2x falls below 25000 pages (100000 kB) in the state illustrated in FIG. 10, Low Memory Killer selects, as a candidate process to be terminated, the process F classified as “HOME_APP”, and terminates the process F. As a result, the memory area 2f for the process F is freed up to increase the free space 2x by the freed area as illustrated in FIG. 11. However, termination of the process F classified as “HOME_APP” decreases the usability of the information processing apparatus.

In contrast in the memory management system 12 according to the embodiment, when the memory manager 121 terminates a process satisfying the trigger condition, the system cache free-up unit 122 frees up the system cache area 2sc to increase the free space 2x. Thus, the free space 2x of the memory 2 can be effectively increased before the memory management system 12 terminates a process with a high priority such as “HOME_APP”, which consequently prevents the memory manager 121 from terminating the process with a high priority. Thus, the memory management system 12 can sufficiently reserve a free space of a memory while preventing forcible termination of a process with a high priority.

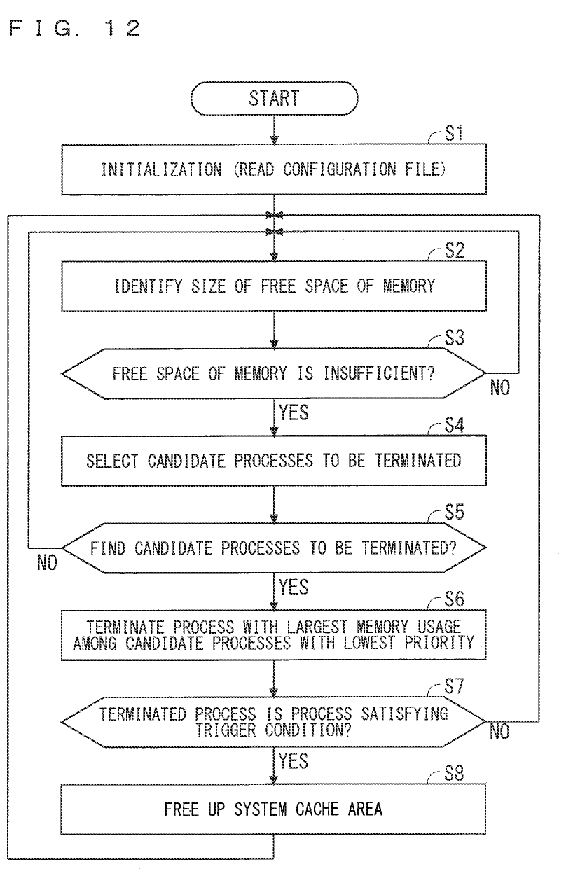

FIG. 12 is a flowchart illustrating the operations of the memory management system 12. The memory management system 12 executes the procedure in FIG. 12 to implement the operations for memory management that are described with reference to FIGS. 4 to 7.

Upon startup of the operating system 10 of the information processing apparatus, the memory management system 12 first reads the configuration file 32 from the storage 3, and initializes the memory manager 121 and the system cache free-up unit 122 based on the description of the configuration file 32 (Step S1). Specifically, the memory management system 12 performs processes of storing, in the memory manager 121, a table representing a relationship between the process genres, the adj-values, and the thresholds of the free space of the memory 2 as illustrated in FIG. 2, and setting the trigger condition to the system cache free-up unit 122.

Next, the memory manager 121 identifies the size of the free space of the memory 2 (Step S2), and determines whether the free space of the memory 2 is insufficient (Step S3). For example, when the table illustrated in FIG. 2 is set to the memory manager 121 and the free space of the memory 2 is smaller than 40000 pages (160000 kB), the memory manager 121 determines that the free space is insufficient. When the free space of the memory 2 is not insufficient (NO in Step S3), Steps S2 and S3 are repeated.

When the free space of the memory 2 is insufficient (YES in Step S3), the memory manager 121 selects candidate processes to be terminated, based on the size of the free space of the memory 2 (Step S4). When the table illustrated in FIG. 2 is set to the memory manager 121 and, for example, the free space of the memory 2 falls below 30000 pages (120000 kB), the memory manager 121 selects processes whose adj-value is 7 or more as the candidate processes to be terminated. When the free space of the memory 2 falls below 20000 pages (80000 kB), the memory manager 121 selects processes whose adj-value is 5 or more as the candidate processes to be terminated. When the memory manager 121 does not find any candidate process to be terminated (NO in Step S5), the processes return to Step S2.

When finding the candidate processes to be terminated (YES in Step S5), the memory manager 121 terminates a process with the largest memory usage in the memory 2 among the candidate processes with the lowest priority (the highest adj-value) to increase the free space of the memory 2 (Step S6). In other words, the memory manager 121 selects a process with the lowest priority from among the candidate processes to be terminated. When finding a plurality of the processes with the lowest priority, the memory manager 121 selects a process with the largest memory usage in the memory 2 from among the processes, and terminates the process finally selected.

After the memory manager 121 terminates the process, the system cache free-up unit 122 checks whether the terminated process is a process satisfying the trigger condition (Step S7). When the terminated process is the process satisfying the trigger condition (YES in Step S7), the system cache free-up unit 122 frees up the system memory area to further increase the free space of the memory 2 (Step S8), and then the processes return to Step S2.

When the process terminated by the memory manager 121 is not the process satisfying the trigger condition (NO in Step S7), the processes return to Step S2 without the system cache free-up unit 122 freeing up the system memory area.

The memory management system 12 repeats these processes.

[Modification]

Generally speaking, the cache area for the operating system 10 (system cache area) includes a page cache area and a slab cache area. Although the system cache free-up unit 122 frees up the entirety of the system cache area in the aforementioned example, the memory manager 121 may free up only one of the page cache area and the slab cache area. This can prevent reduction in the rate of reaction of the operating system 10 due to the operations of the system cache free-up unit 122 more than that when the system cache free-up unit 122 frees up the entirety of the system cache area.

For example, whether the system cache free-up unit 122 frees up only the page cache area, only the slab cache area, or both the page cache area and the slab cache area may be set to each information processing apparatus. In such a case, a set value indicating which area the system cache free-up unit 122 frees up should be described in the configuration file 32. Upon startup of the operating system 10 (for example, Step S1 in FIG. 12), the system cache free-up unit 122 should read the set value from the configuration file 32.

Although Android is used as the example of the operating system 10 in the description above, the present invention is applicable to the operating system 10 including the memory manager 121 that terminates an running process when a free space of the memory 2 is insufficient to reserve the free space of the memory, for example, iOS (registered trademark), Windows (registered trademark), or Linux (registered trademark). Since the memory manager 121 to be combined with the system cache free-up unit 122 may be a common unit such as Low Memory Killer, the present invention has greater versatility.

Within the scope of the present invention, the embodiment can be appropriately modified or omitted.

Although this invention has been described in detail, the description is in all aspects illustrative and does not restrict the invention. Therefore, numerous modifications that have not yet been exemplified will be devised without departing from the scope of this invention.

### EXPLANATION OF REFERENCE SIGNS

1 processor, 2 memory, 3 storage, 10 operating system, 11 process execution unit, 12 memory management system, 121 memory manager, 122 system cache free-up unit, 31 system software, 32 configuration file, 33 applications.

1-9. (canceled)

10. An information processing apparatus, comprising:
a processor to execute a plurality of processes; and
a memory to be used by the processor to execute the plurality of processes,
wherein the processor performs:
a memory management process for monitoring a free space of the memory and terminating any of running processes upon detecting a shortage of the free space of the memory to increase the free space of the memory; and
a system cache free-up process for freeing up, in the memory, an area reserved as a cache area of an operating system to further increase the free space of the memory when a type or an operating state of the process terminated in the memory management process satisfies a predefined condition.

11. The information processing apparatus according to claim 10,
wherein in the system cache free-up process, the cache area is freed up when the process terminated in the memory management process is a process whose operation cannot be perceived by a user.

12. The information processing apparatus according to claim 10,
wherein in the system cache free-up process, the cache area is freed up when the process terminated in the memory management process is a process for sharing data with another process.

13. The information processing apparatus according to claim 10,
wherein in the system cache free-up process, the cache area is freed up when the process terminated in the memory management process is a process during which none is executed.

14. The information processing apparatus according to claim 10,
wherein the processor is capable of setting the cache area to be freed up in the system cache free-up process to a page cache area, a slab cache area, or both the page cache area and the slab cache area.

15. The information processing apparatus according to claim 10,
wherein upon detection of the shortage of the free space of the memory, in the memory management process, which one of the plurality of processes is to be terminated is selected, based on one or more of the free space of the memory, the type and the operating state of each of the processes, and a memory usage in the memory through the process.

16. The information processing apparatus according to claim 10,
wherein a priority of each of the plurality of processes is defined based on the type or the operating state of the process, and
in the memory management process:
upon detecting the shortage of the free space of the memory, the processor selects a candidate process to be terminated, based on the flee space of the memory;
in the presence of a plurality of candidate processes to he terminated, the processor terminates a process with a lowest priority among the plurality of candidate processes; and
in the presence of a plurality of processes with the lowest priority among the plurality of candidate processes to be terminated, the processor terminates a process with a largest memory usage in the memory among the plurality of processes with the lowest priority.

17. A method for managing a memory to be used for executing a plurality of processes, the method comprising:
monitoring a free space of the memory and terminating any of running processes upon detection of a shortage of the free space of the memory so that the free space of the memory is increased: and
freeing up, in the memory, an area reserved as a cache area of an operating system so that the free space of the memory is further increased when a type or an operating state of the terminated process satisfies a predefined condition.
